(19) United States
(12) Patent Application Publication
(10) Pub. No.: US 2024/0205795 A1
(43) Pub. Date: Jun. 20, 2024

(54) METHODS FOR ENABLING INTER-DONOR ROUTING IN IAB NETWORKS

(71) Applicant: Telefonaktiebolaget LM Ericsson (publ), Stockholm (SE)

(72) Inventors: Filip BARAC, Huddinge (SE); Marco BELLESCHI, Solna (SE); Ritesh SHREEVASTAV, Upplands Väsby (SE); Jose Luis PRADAS, Stockholm (SE)

(21) Appl. No.: 18/551,509

(22) PCT Filed: Mar. 21, 2022
(86) PCT No.: PCT/IB2022/052571

§ 371 Date: Sep. 20, 2023

Related U.S. Application Data
(60) Provisional application No. 63/164,441, filed on Mar. 22, 2021.

(51) Int. Cl. H04W 40/36

(52) U.S. Cl. CPC H04W 40/36

(57) ABSTRACT

A method, system and apparatus are disclosed. A first integrated access and backhaul, IAB, node in communication with a second IAB node, a first network node, and a second network node is provided. The first IAB node receives an instruction from at least one of the first and second network nodes, the instruction being associated with a traffic migration of traffic routed via the first IAB node, the traffic migration being from the first network node to the second network node. The first IAB node receives an uplink, UL, packet from the second IAB node, where the UL packet includes a first address indicator, and modifies the UL packet, including adding a second address indicator associated with the first IAB node to the UL packet, the modifying being based on the instruction. The first IAB node transmits the UL packet to the second network node.

### CROSS-REFERENCE TO RELATED APPLICATION

This application claims priority to U.S. Provisional Application No. 63/164,441, filed Mar. 22, 2021, which is hereby incorporated by reference in its entirety.

### FIELD

The present disclosure relates to wireless communications, and in particular, to inter-donor routing in integrated access and backhaul (IAB) networks.

### BACKGROUND

### Integrated Access and Backhaul Networks (Third Generation Partnership Project (3GPP) Release 16 Baseline)

### Protocol and Architecture Overview

The usage of short range mmWave spectrum in New Radio (NR, also referred to as 5th Generation (5G)) creates a need for densified deployment with multi-hop backhauling. However, optical fiber to every base station may be too costly and sometimes not even possible such as in, for example, historical sites. One IAB principle is the use of wireless links for the backhaul (instead of optical fiber) to enable flexible and very dense deployment of cells without the need for densifying the transport network. Use case scenarios for IAB can include coverage extension, deployment of massive number of small cells and fixed wireless access (FWA) (e.g., to residential/office buildings). The larger bandwidth available for NR in mmWave spectrum provides an opportunity for self-backhauling, without limiting the spectrum to be used for the access links. Further, the inherent multi-beam and MIMO support in NR may reduce cross-link interference between backhaul and access links allowing higher densification.

During a study item phase of IABs (a summary of the study item can be found in 3GPP Technical Report (TR) 38.874), adopting a solution that leverages the Central Unit (CU)/Distributed Unit (DU) split architecture of NR, where the IAB node may be hosting a DU part that is controlled by a central unit was described. The IAB nodes also have a Mobile Termination (MT) part that they use to communicate with their parent IAB nodes.

The specifications for IAB strive to reuse existing functions and interfaces defined in NR. In particular, MT, gNB-DU, gNB-CU, UPF, AMF and SMF as well as the corresponding interfaces NR Uu (between MT and gNB (i.e., IAB node)), F1, NG, X2 and N4 are used as baseline for the IAB architectures. Modifications or enhancements to these functions and interfaces for the support of IAB will be explained in the context of the architecture discussion. Additional functionality such as multi-hop forwarding is included in the architecture discussion as it is useful for the understanding of IAB operation and since certain aspects may require standardization. The Mobile-Termination (MT) function has been defined as a component of the IAB node. MT is referred to as a function residing on an IAB-node that terminates the radio interface layers of the backhaul Uu interface toward the IAB-donor or other IAB-nodes.

FIG. 1 is a reference diagram of an example IAB in standalone mode, which contains one IAB-donor and multiple IAB-nodes, as described in, for example, 3GPP TR 38.874. The IAB-donor is treated as a single logical node that comprises a set of functions such as gNB-DU, gNB-CU-CP, gNB-CU-UP and potentially other functions. In a deployment, the IAB-donor can be split according to these functions, which can all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks.

The baseline user plane and control plane protocol stacks for IAB are shown in FIGS. 2 and 3. In particular, FIG. 2 is a diagram of a baseline user plane (UP) protocol stack for IAB in 3GPP Rel-16 while FIG. 3 is a diagram of a baseline control plane (CP) protocol stack for IAB in Rel-16.

As illustrated in FIGS. 2 and 3, the chosen protocol stacks reuse the current CU-DU split specification that is described in 3GPP Rel-15, where the full user plane F1-U (General Packet Radio Service (GPRS) Tunnelling Protocol Unit (GTP-U)/User Datagram Protocol (UDP)/Internet Protocol (IP)) is terminated at the IAB node (like a typical DU) and the full control plane F1-C (F1-AP/SCTP/IP) is also terminated at the IAB node (like a typical DU). In the above cases, Network Domain Security (NDS) has been employed to protect both UP and CP traffic (IPsec in the case of UP, and DTLS in the case of CP). IPsec could also be used for the CP protection instead of DTLS (in this case no DTLS layer would be used).

A new protocol layer called Backhaul Adaptation Protocol (BAP) has been introduced in the IAB nodes and the IAB donor, which is used for routing of packets to the appropriate downstream/upstream node and also mapping the wireless device bearer data to the proper backhaul radio link control (RLC) channel (and also between ingress and egress backhaul RLC channels in intermediate IAB nodes) to satisfy the end-to-end QoS requirements of bearers.

### BAP Entities

On the IAB-node, the BAP sublayer contains one BAP entity at the MT function and a separate co-located BAP entity at the DU function. On the IAB-donor-DU, the BAP sublayer may contain only one BAP entity. Each BAP entity has a transmitting part and a receiving part. The transmitting part of the BAP entity has a corresponding receiving part of a BAP entity at the IAB-node or IAB-donor-DU across the backhaul link.

FIG. 4 is a diagram of an example of the functional view of the BAP sublayer. FIG. 4 is based on the radio interface protocol architecture defined in, for example, 3GPP Technical Specification (TS) 38.300. In the example of FIG. 4, the receiving part on the BAP entity delivers BAP PDUs to the transmitting part on the collocated BAP entity. Alternatively, the receiving part may deliver BAP SDUs to the collocated transmitting part. When passing BAP SDUs, the receiving part removes the BAP header, and the transmitting part adds the BAP header with the same BAP routing ID as carried on the BAP PDU header prior to removal. Passing BAP SDUs in this manner is therefore functionally equivalent to passing BAP PDUs, in implementation.

The following services may be provided by the BAP sublayer to upper layers: data transfer.

A BAP sublayer expects the following services from lower layers per RLC entity (as described in, for example, 3GPP TS 38.322): acknowledged data transfer service and unacknowledged data transfer service.

The BAP sublayer supports the following example functions:
Data transfer;
Determination of BAP destination and path for packets from upper layers;
Determination of egress backhaul (BH) RLC channels for packets routed to next hop;
Routing of packets to next hop;
Differentiating traffic to be delivered to upper layers from traffic to be delivered to egress link;
Flow control feedback and polling signaling;

### Topology Adaptation Scenarios for Baseline Architecture

FIG. 5 is a diagram of an example of some possible IAB-node migration cases listed in the order of complexity and more details as follow:
Intra-CU Case (A): In this case the IAB-node (e) along with it serving UEs (i.e., wireless devices) is moved to a new parent node (IAB-node (b)) under the same donor-DU (1). The successful intra-donor DU migration may require establishing UE context setup for the IAB-node (e) MT in the DU of the new parent node (IAB-node (b)), updating routing tables of IAB nodes along the path to IAB-node (e) and allocating resources on the new path. The IP address for IAB-node (e) will not change, while the F1-U tunnel/connection between donor-CU (1) and IAB-node (e) DU will be redirected through IAB-node (b).
Intra-CU Case (B): The procedural requirements/complexity of this case is the same as that of Case (A). Also, since the new IAB-donor DU (i.e., DU2) is connected to the same L2 network, the IAB-node (e) can use the same IP address under the new donor DU. However, the new donor DU (i.e., DU2) may need to inform the network using IAB-node (e) L2 address in order to get/keep the same IP address for IAB-node (e) by employing some mechanism such as Address Resolution Protocol (ARP).
Intra-CU Case (C): This case is more complex than Case (A) as it also needs allocation of new IP address for IAB-node (e). In case, IPsec is used for securing the F1-U tunnel/connection between the Donor-CU (1) and IAB-node (e) DU, then it might be possible to use existing IP address along the path segment between the Donor-CU (1) and SeGW, and new IP address for the IPsec tunnel between SeGW and IAB-node (e) DU.
Inter-CU Case (D): This is a complicated case in terms of procedural requirements and may needs new specification procedures (such as enhancement of radio resource control (RRC), F1 application protocol (AP), XnAP, Ng signaling) that are beyond the scope of 3GPP Rel-16.

Note that 3GPP Rel-16 has standardized procedure only for intra-CU migration, which is described below.

### Intra-CU Topology Adaptation Procedure

During the intra-CU topology adaptation, both the source and the target parent IAB node are served by the same IAB-donor-CU. The target parent IAB node may use a different IAB-donor-distributed unit (DU) than the source parent IAB node. The source path may further have common IAB nodes with the target path. FIG. 6 is a signaling diagram of an example of the topology adaptation procedure, where the target parent IAB node uses a different IAB-donor-DU than the source parent IAB node.

The steps in the example of FIG. 6 are described below.
1. The migrating IAB-MT sends a Measurement Report message to the source parent IAB node gNB-DU. This report is based on a Measurement Configuration the migrating IAB-MT received from the IAB-donor-CU before.
2. The source parent IAB node gNB-DU sends an UL RRC MESSAGE TRANSFER message to the IAB-donor-CU to convey the received Measurement Report.
3. The IAB-donor-CU sends a UE CONTEXT SETUP REQUEST message to the target parent IAB node gNB-DU to create the UE context for the migrating IAB-MT and setting up one or more bearers. These bearers are used by the migrating IAB-MT for its data and signaling traffic.
4. The target parent IAB node gNB-DU responds to the IAB-donor-CU with a UE CONTEXT SETUP RESPONSE message.
5. The IAB-donor-CU sends a UE CONTEXT MODIFICATION REQUEST message to the source parent IAB node gNB-DU, which includes a generated RRCReconfiguration message. The Transmission Action Indicator in the UE CONTEXT MODIFICATION REQUEST message indicates to stop the data transmission to the migrating IAB-node.
6. The source parent IAB node gNB-DU forwards the received RRCReconfiguration message to the migrating IAB-MT.
7. The source parent IAB node gNB-DU responds to the IAB-donor-CU with the UE CONTEXT MODIFICATION RESPONSE message.
8. A Random Access procedure is performed at the target parent IAB node gNB-DU.
9. The migrating IAB-MT responds to the target parent IAB node gNB-DU with an RRCReconfigurationComplete message.
10. The target parent IAB node gNB-DU sends an UL RRC MESSAGE TRANSFER message to the IAB-donor-CU to convey the received RRCReconfigurationComplete message. Also, uplink packets can be sent from the migrating IAB-MT, which are forwarded to the IAB-donor-CU through the target parent IAB node gNB-DU. These DL and UL packets belong to the MT's own signaling and data traffic.
11. The IAB-donor-CU configures BH RLC channels and BAP-layer route entries on the target path between migrating IAB-node and target IAB-donor-DU. This step also includes allocation of TNL address(es) that is (are) routable via the target IAB-donor-DU. These configurations may be performed at an earlier stage, e.g., right after step 3. The new TNL address(es) is (are) included in the RRCReconfiguration message at step 5.
12. All F1-U tunnels and F1-C are switched to use the migrating IAB-node's new TNL address(es).
13. The IAB-donor-CU sends a UE CONTEXT RELEASE COMMAND message to the source parent IAB node gNB-DU.
14. The source parent IAB node gNB-DU releases the migrating IAB-MT's context and responds the IAB-donor-CU with a UE CONTEXT RELEASE COMPLETE message.
15. The IAB-donor-CU releases BH RLC channels and BAP routing entries on the source path. The migrating IAB-node may further release the TNL address(es) it used on the source path.

NOTE: In case that the source route and target route have common nodes, the BH RLC channels and BAP routing entries of those nodes may not need to be released in Step 15.

NOTE: Steps 11, 12 and 15 may also have to be performed for the migrating IAB-node's descendant nodes, as follows:
A. The descendant IAB nodes may also have to switch to new TNL addresses that are anchored in the target IAB-donor-DU. The IAB-donor-CU may send these addresses to the descendant IAB nodes and release the old addresses via corresponding RRC signaling.
B. If needed, the IAB-donor-CU configures BH RLC channels, BAP-layer route entries on the target path for the descendant IAB nodes and the BH RLC Channel mappings on the descendant IAB nodes in the same manner as described for the migrating IAB-node in step 11.
C. The descendant IAB nodes switch their F1-U and F1-C tunnels to new TNL addresses that are anchored at the new IAB-donor-DU, in the same manner as described for the migrating IAB-node in step 12.
D. Based on implementation, these steps can be performed after or in parallel with the handover of the migrating IAB-node. In 3GPP Rel-16, in-flight packets in UL direction that were dropped during the migration procedure may not be recoverable.

NOTE: In upstream direction, in-flight packets between the source parent IAB node and the IAB-donor-CU can be delivered even after the target path is established.

NOTE: On-going downlink data in the source path may be discarded up to implementation.

NOTE: IAB-donor-CU can determine the unsuccessfully transmitted downlink data over the backhaul link by implementation.

### Proxied Inter-CU Migration

3GPP Rel-16 has provided/standardized only an intra-CU topology adaptation procedure. Considering that inter-CU migration may be an important feature of IAB 3GPP Rel-17 work item (WI), enhancements to existing procedure may be required for reducing service interruption (due to IAB-node migration) and signaling load. For example, if existing mechanisms (in 3GPP TR 38.874) are adopted for inter-CU migration (Case(D) in FIG. 5) as is, then a new F1 connection is set up from IAB-node E to the new CU (i.e., CU(2)) and the old F1 connection to the old CU (i.e., CU(1)) is released.

Releasing and relocating the F1 connection will impact all UEs (i.e., UEc, UEd, and UEe) and any descendant IAB nodes (and their served UEs) by causing:

1. service interruption for the UEs and IAB nodes served by the migrating IAB node (i.e., IAB-node E) since these UEs may need to re-establish their connection or to perform handover operation (even if they remain under the same IAB node, as 3GPP security principles mandate to perform key refresh whenever the serving CU/gNB is changed (e.g., at handover or reestablishment), i.e., RRC reconfiguration with reconfiguration WithSync has to be sent to each UE).

2. a signaling storm: since a large number of UEs, IAB-MTs and IAB-DUs have to perform re-establishment or handover at the same time, there may be a surge or “storm” in signaling due to the releasing and relocation of the F1 connection.

In addition, it may be preferred that any reconfiguration of the descendant IAB nodes of the migrating IAB node (which may be referred to as the top-level node) is avoided. This means that the descendant IAB nodes should preferably be unaware of the fact that the traffic is proxied via CU2.

To help address the above problems, a proxy-based mechanism has been proposed where the inter-CU migration is performed without handing over the UEs (i.e., wireless devices) or IAB nodes directly or indirectly being served by the migrating IAB node, thereby making the handover of the directly and indirectly served UEs transparent to the target CU. In particular, only the RRC connection of the migrating IAB node is migrated to the target CU, while the CU-side termination of its F1 connection as well as the CU-side terminations of the F1 and RRC connections of its directly and indirectly served IAB nodes and UEs are kept at the source CU. In this case, the target CU serves as the proxy for these F1 and RRC connections that are kept at the source CU.

Consider the example scenario in FIG. 7 that illustrates the protocol stacks and signal flow when the F1 connections are maintained in the CU-1, while FIG. 8 illustrates how the F1-U is tunneled over the Xn and then transparently forwarded to the IAB donor-DU-2 after the IAB node is migrated to the target donor CU (i.e., CU2).

Existing 3GPP Rel-17 agreements provide for proxied inter-CU migration, as described above.

3GPP Release-16 requirements with respect to IP addressing in IAB networks and an example of their implications on inter-donor load balancing

The 3GPP Rel-16 IAB specifications are based on the following example assumptions/requirements:

(Requirement 1) The IP addresses of all IAB nodes under a donor DU belong to one IP address domain. This effectively means that each downlink packet reaching a donor DU must bear a destination IP address pertaining to the IP address domain of that donor DU. Otherwise, the packet will likely be discarded by the donor DU.
If Ipsec tunnel mode is used to protect the traffic, the destination IP address that the donor DU is inspecting and has access to refers to the outer IP address. In other cases (Ipsec transport mode or no Ipsec is used), there is only one IP header in the packet and hence one destination IP address in the header.

(Requirement 2) An Ipsec tunnel protecting the traffic for an F1 connection must be end-to-end, i.e., the tunnel continuously stretches from the CU to the DU terminating the two ends of the F1 connection. This means that the end-to-end security requirement cannot be satisfied by concatenation of two or more different Ipsec tunnels.

For the sake of traffic load balancing, the traffic previously sent from the source donor (i.e., CU_1 in FIG. 9) to the top-level IAB node (IAB3) and its descendants (e.g., IAB4) is offloaded (i.e., proxied) via CU_2.
For example, the old traffic path from CU_1 to IAB4, i.e., CU_1-Donor DU_1-IAB2-IAB3-IAB4 is, for load balancing purposes, changed to CU_1-Donor DU_2-IAB5-IAB3-IAB4.

Herein, the assumption is that direct routing between CU_1 and Donor DU_2 is applied (i.e., CU_1-Donor DU_1-and so on . . . ), rather than the indirect routing case CU_1-CU_2-Donor DU_1-and so on . . . ). The direct routing can, e.g., be supported via IP routing between (source donor) CU_1 and donor DU2 (target donor DU) or via an Xn connection between the two. In indirect routing, data can be sent between CU_1 and CU_2 via Xn interface, and between CU_2 and Donor DU_2 via F1 or via IP routing. The advantage of direct routing is that the latency is likely smaller.

In this case, Donor DU_2 receives a DL packet from CU_1, and, based on destination IP address and/or DSCP/DS and/or flow label, Donor DU_2 determines the BAP routing ID to be appended to the packet, determines the next-hop IAB node and the next-hop BH RLC channel to be used.

If IPsec tunnel mode is used to protect the traffic, the destination IP address refers to the outer IP address and DSCP/DS and flow label refer to the fields in the outer IP header. In other cases (IPsec transport mode or no IPsec is used), there is only one IP header in the packet and hence one destination IP address, DSCP/DS and flow label in the packet header.

The CU_1 sets the destination IP address and/or DSCP/DS and/or flow label for the packets that it sends to the Donor DU_2, as instructed by CU_2.

### An Example of Proxy-Based Solution for Inter-Donor Load Balancing

As discussed above, 3GPP has agreed that, for the scenarios of inter-donor load balancing and inter-donor RLF recovery, the proxy-based solution described above may be supported. Applied to the scenario from the example of FIG. 9, the proxy-based solution works as follows:
IAB3-MT changes its RRC connection (i.e., association) from CU_1 to CU_2.
Meanwhile, the RRC connections of IAB4-MT and all the UEs served by IAB3 and IAB4, as well as the F1 connections of IAB3-DU and IAB4-DU would remain anchored at CU_1 (i.e., they are not moved to CU_2), whereas the corresponding traffic of these connections is sent to and from the IAB3/IAB4 and their served UEs by using a path via CU_2 (CU_1-Donor DU_2-IAB5-IAB3-IAB4 as described above).

With respect to the example scenario shown in FIG. 9, if the link between IAB2 and IAB3 becomes congested, it may be necessary to execute load balancing, by offloading, from CU_1 (referred to as the source CU or old CU) to CU_2 (referred to as the target CU or new CU), the traffic destined to IAB3, IAB4 and the UEs that the two are serving.

The offloading would be executed by inter-donor rerouting of traffic. For example, for the traffic between CU_1 and IAB4, offloading to CU_2 means that the traffic path from CU_1-Donor DU_1-IAB2-IAB3-IAB 4 is changed to a path via the target donor (referred to as the new path): CU_1-Donor DU_2-IAB5-IAB3. In this case, the IAB3 (referred to as the top-level node or the migrating node), would change its parent IAB from IAB2 (under CU_1) to IAB5 (under CU_2).

As describe above, it was discussed that the above may be enabled by the proxy-based solution, where the IAB3-MT changes its RRC connection (i.e., association) from CU_1 to CU_2. Meanwhile, the RRC connections of IAB4-MT and all the UEs served by IAB3 and IAB4, as well as the F1 connections of IAB3-DU and IAB4-DU would remain anchored at CU_1, whereas the corresponding traffic of these connections would be sent to and from the IAB3/IAB4 and their served UEs by using the new path (as described above).

The 3GPP Rel 16 IAB specifications are based on the following example assumptions:

(Requirement 1) The IP addresses of all IAB nodes under a donor DU belong to one IP address domain. This effectively means that each downlink packet reaching a donor DU must bear a destination IP address pertaining to the IP address domain of that donor DU. Otherwise, the packet will likely be discarded by the donor DU. Herein, if IPsec tunnel mode is used to protect the traffic, the destination IP address that the donor DU is inspecting and has access to refers to the outer IP address. In other cases (IPsec transport mode or no IPsec is used), there is only one IP header in the packet and hence one destination IP address in the header.

(Requirement 2) An IPsec tunnel protecting the traffic for an F1 connection must be end-to-end, i.e., the tunnel continuously stretches from the CU to the DU terminating the two ends of the F1 connection. This means that the end-to-end security requirement cannot be satisfied by concatenation of two or more IPsec tunnels.

With respect to the scenario shown in FIG. 9, if the link between IAB2 and IAB3 becomes congested, it may be necessary to execute load balancing, by offloading, from CU_1 to CU_2, the traffic destined to IAB3, IAB4 and the UEs that the two are serving.

The offloading would be executed by inter-donor rerouting of traffic. For example, for the traffic between CU_1 and IAB4, offloading to CU_2 means that the traffic path from CU_1-Donor DU_1-IAB2-IAB3-IAB 4 is changed to a path via the target donor: CU_1-Donor DU_2-IAB5-IAB3. In this case, the IAB3 would change its parent from IAB2 (under CU_1) to IAB5 (under CU_2).

It was agreed that the above may be enabled by the proxy-based solution, where the IAB3-MT changes its RRC connection (i.e., association) from CU_1 to CU_2. Meanwhile, the RRC connections of IAB4-MT and all the UEs served by IAB3 and IAB4, as well as the F1 connections of IAB3-DU and IAB4-DU would remain anchored at CU_1, whereas the corresponding traffic of these connections would be sent to and from the IAB3/IAB4 and their served UEs by using the new path (as described above).

If the above two 3GPP Rel-16 requirements/assumptions are applied to the example scenario from FIG. 9 (which is addressed in 3GPP Rel-17), then these two requirements will conflict with each other. Namely:
The fact that IAB3-DU and IAB4-DU maintain their F1 connections to CU_1 even after IAB3-MT has migrated to CU_2 means that, e.g., F1 packets from CU_1 to IAB3-DU and IAB4-DU (and the UEs served therein) must contain the destination IP address pertaining to the IP address domain of Donor DU_1, as per Requirement 1.
On the other hand, as per Requirement 2, F1 packets from CU_1 to IAB3-DU and IAB4-DU (and the UEs served therein) must contain the destination IP address pertaining to the IP address domain of Donor DU_2 (herein referred to as the target donor DU).

The contradiction is hence related to the fact that, according to Requirement 1, the destination IP address of the downlink (DL) packet from CU_1 to IAB4 arriving at Donor DU_2 must be from the IP address domain of Donor DU_2. However, according to the Requirement 2, the DL packet from CU_1 to IAB4 must carry the destination IP address pertaining to the IPsec tunnel between the two (i.e., the outer IP address)—this IP address belongs to the IP address domain of Donor DU_1.

Similarly, for uplink (UL) traffic originating at IAB3-DU, IAB4-DU or the UEs served by the two, due to the Requirement 2, the packets will bear a destination address from the IP address domain of Donor DU_1, which may be discarded by Donor DU_2, since they belong to another IP address domain. Therefore, existing solutions fail to address how the above contradiction is to be handled in the 3GPP Rel-17 inter-donor routing scenario.

### SUMMARY

Some embodiments advantageously provide methods, systems, and apparatuses for IAB networks such as based on, for example, an additional IP header.

One or more embodiments described herein may provide one or more of the following:
A method for packet handling at the source donor, where an additional IP header is added to the IP packet, on top of the existing outer IPsec header (of the one and only IP header, if IPsec transport mode is used or no IPsec is used at all), and where the additional IP header bears the destination IP address pertaining to the IP domain of target donor DU.
A procedure for the target donor DU (Donor DU_2) to build the BAP header based on the additional IP header and forward the packet over the backhaul.
A method at the migrating (i.e., top-level) IAB node to determine if the received BAP packet contains DL/UL data destined to it or not based at least on the IP header, and remove (for DL traffic) or assemble and append (for UL traffic) the additional IP header and build a BAP header (including the resulting IP packet).

Hence, one or more embodiments provide one or more mechanisms for handling the IP packet headers of traffic routed between two donors, while avoiding IP address reconfiguration of descendant nodes of the migrating (i.e., top-level) IAB node.

Both direct and indirect routing may be applicable to one or more of these embodiments.

According to one aspect of the present disclosure, a method implemented in a first network node in communication with a second network node and a first integrated access and backhaul, IAB, node which is in communication with a second IAB node is provided. The first network node is associated with a first address indicator. The method includes detecting a need for a traffic migration of traffic routed via the first IAB node, where the traffic migration is from the first network node to the second network node. In response to the detecting, the method includes sending a request to the second network node. The method includes receiving, from the second network node in response to the request, a second address indicator associated with the first IAB node. The method includes causing transmission of an instruction to the first IAB node. The instruction is associated with the traffic migration and is configured to cause the first IAB node modify a downlink, DL, packet prior to routing the DL packet to the second IAB node or modify an uplink, UL, packet originating from the second IAB node prior to routing the UL packet. The method includes causing transmission of the DL packet to the second network node, where the DL packet is destined for the second IAB node and is routed via the first IAB node, and the DL packet includes the first address indicator and the second address indicator, or the method includes receiving the UL packet from the second network node, where the received UL packet originates from the second IAB node and is routed via the first IAB node.

According to another aspect of the present disclosure, a first network node in communication with a second network node and a first integrated access and backhaul, IAB, node which is in communication with a second IAB node is provided, which includes hardware configured to perform the method described in the preceding paragraph.

According to another aspect of the present disclosure, a method implemented in a first IAB node in communication with a second IAB node, a first network node, and a second network node is provided. The method includes receiving an instruction from at least one of the first network node and the second network node, where the instruction is associated with a traffic migration of traffic routed via the first IAB node, and the traffic migration is from the first network node to the second network node. The method includes receiving a downlink, DL, packet from the second network node, where the DL packet includes a first address indicator and a second address indicator. The method includes modifying the DL packet, where the modifying includes removing the second address indicator from the DL packet and is based on the instruction. The method includes and causing transmission of the DL packet to the second IAB node based on the first address indicator being associated with the second IAB node

According to another aspect of the present disclosure, a first IAB node in communication with a second IAB node, a first network node, and a second network node is provided, which includes hardware configured to perform the method described in the preceding paragraph.

According to another aspect of the present disclosure, a method implemented in a first IAB node in communication with a second IAB node, a first network node, and a second network node is provided. The method comprises receiving an instruction from at least one of the first network node and the second network node, where the instruction is associated with a traffic migration of traffic routed via the first IAB node. The traffic migration is from the first network node to the second network node. The method includes receiving an uplink, UL, packet from the second IAB node, where the UL packet includes a first address indicator. The method includes modifying the UL packet, where the modifying includes adding a second address indicator associated with the first IAB node to the UL packet and is based on the instruction. The method includes causing transmission of the UL packet to the second network node.

According to another aspect of the present disclosure, a first IAB node in communication with a second IAB node, a first network node, and a second network node, the first IAB node is provided, which includes hardware configured to perform the method described in the preceding paragraph.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a IAB architecture;

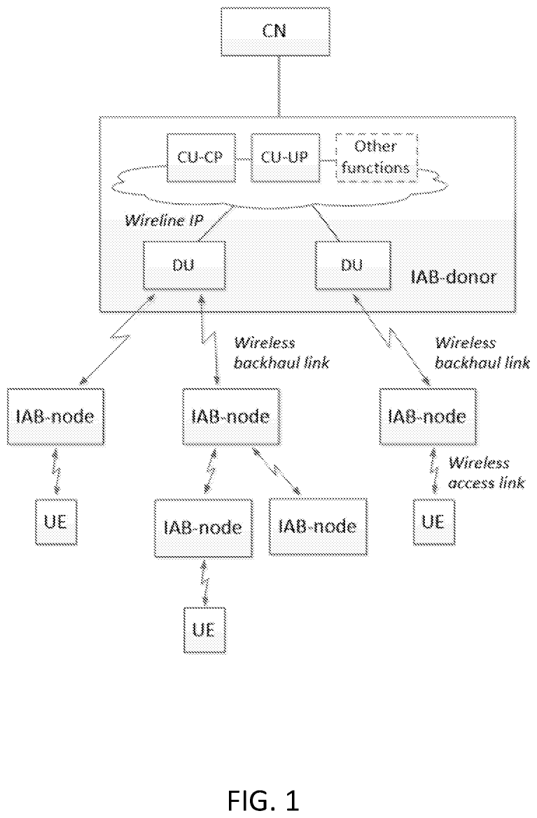

FIG. 2 is a diagram of a baseline user plane (UP) protocol stack for IAB;

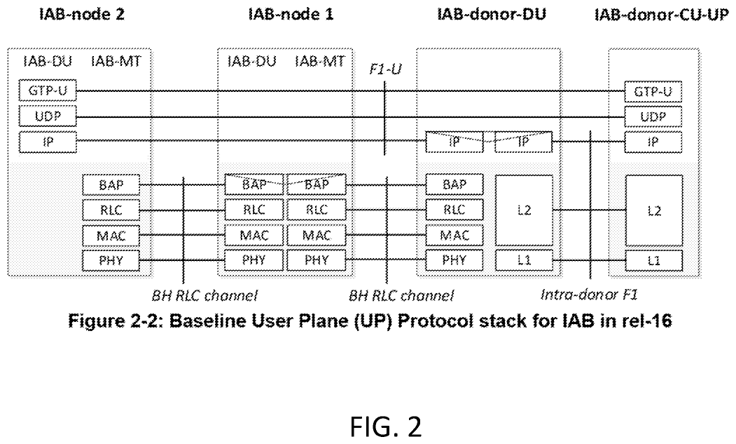

FIG. 3 is a diagram of a baseline control plane protocol stack for IAB;

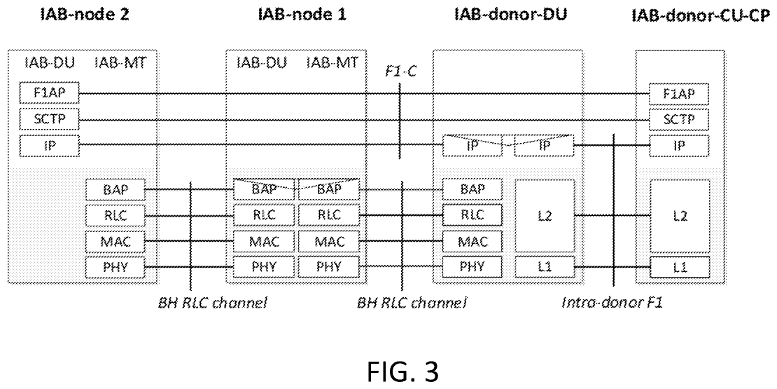

FIG. 4 is a diagram for a function view of BAP sublayer;

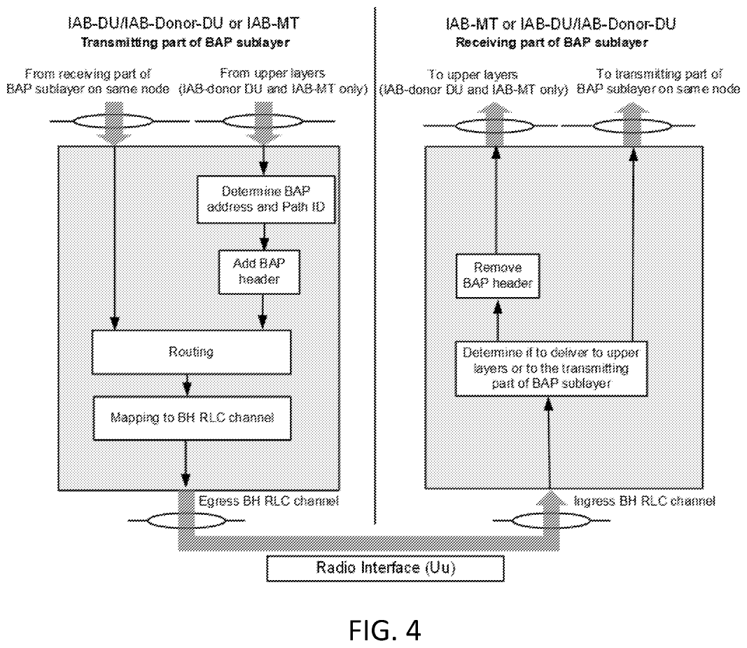

FIG. 5 is a diagram of scenarios for IAB node migration;

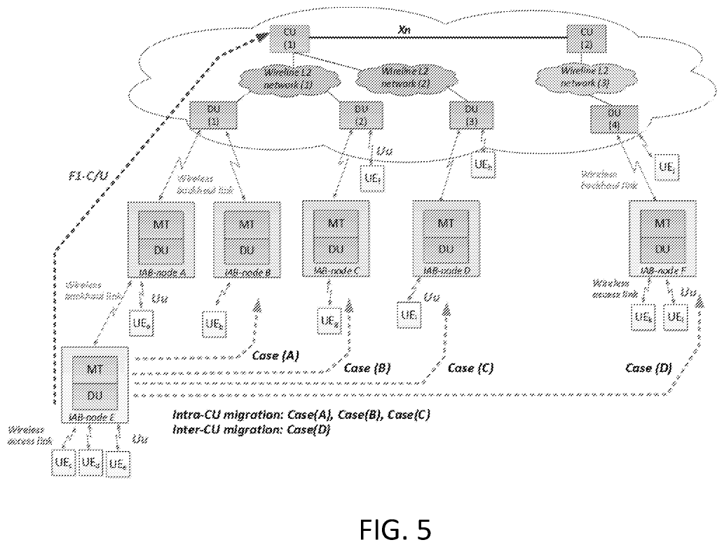

FIG. 6 is a signaling diagram of IAB intra-CU topology adaptation procedure;

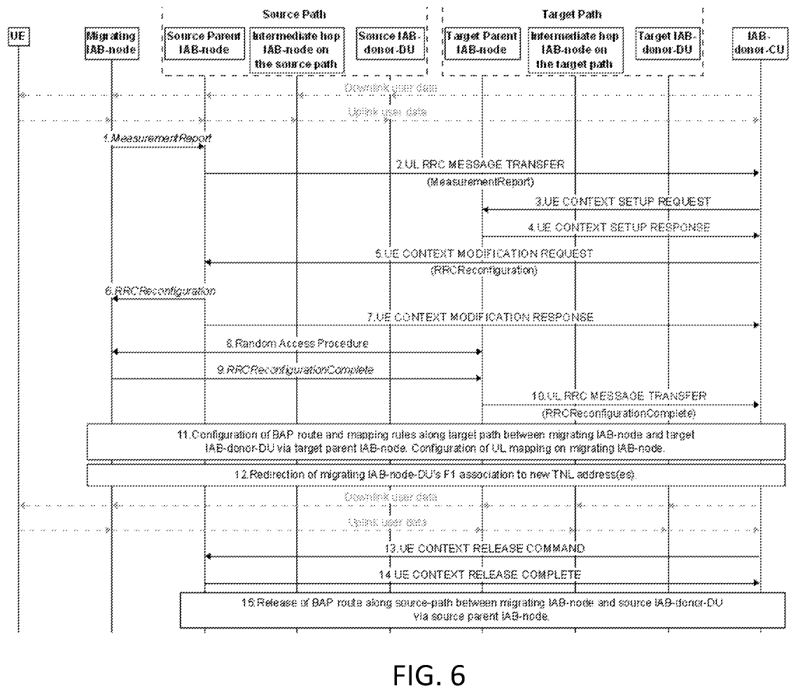

FIG. 7 is a diagram of signaling flow before IAB node 3 migration;

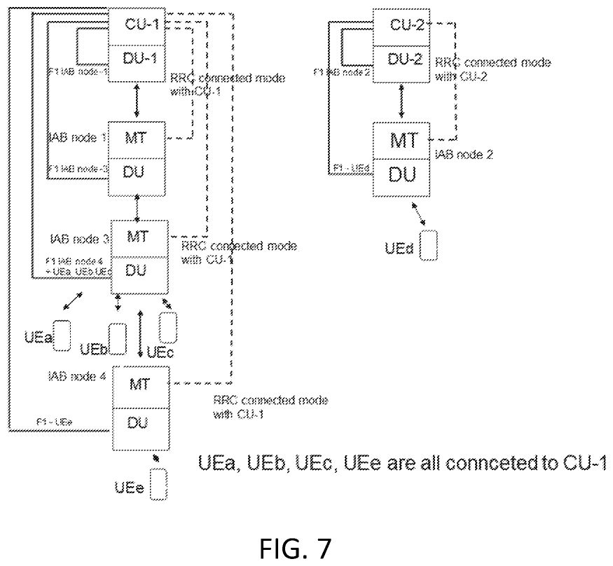

FIG. 8 is a diagram of signaling flow after IAB node 3 migration;

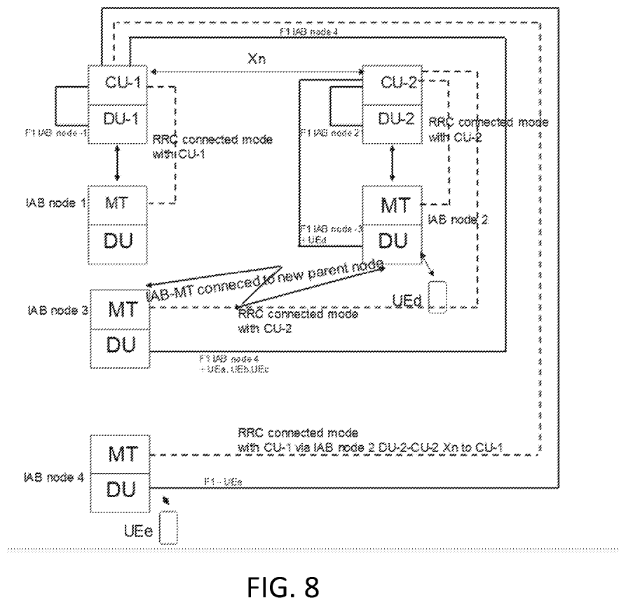

FIG. 9 is a diagram of inter-donor load balancing scenario involving IAB node 3 and its descendant node IAB4 and UEs that these two IAB nodes are serving;

FIG. 10 is a schematic diagram of an example network architecture illustrating a communication system according to principles disclosed herein;

FIG. 11 is a block diagram of a IAB node in communication with a wireless device and other IAB nodes according to some embodiments of the present disclosure;

FIG. 12 is a flowchart of an example process in a source IAB node according to some embodiments of the present disclosure;

FIG. 13 is a flowchart of an example process in target IAB node according to some embodiments of the present disclosure;

FIG. 14 is a flowchart of an example process in a top-level IAB node according to some embodiments of the present disclosure;

FIG. 15 is a flowchart of an example process in a first network node according to some embodiments of the present disclosure;

FIG. 16 is a flowchart of an example process in a first IAB node according to some embodiments of the present disclosure;

FIG. 17 is a flowchart of an example process in a first IAB node according to some embodiments of the present disclosure; and

FIG. 18 is a block diagram of additional IP header addition according to some embodiments of the present disclosure.

### DETAILED DESCRIPTION

Before describing in detail example embodiments, it is noted that the embodiments reside primarily in combinations of apparatus components and processing steps related to inter-donor routing in integrated access and backhaul (IAB) networks. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second.” “top” and “bottom.” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof. As used herein, the term “modify,” as in the phrase “modify a packet,” may include adding, editing, and/or removing information, e.g., from one or more fields, headers, etc. of a packet. The phrase “modify a packet” may include generating and/or regenerating a new packet based on an existing packet, e.g., with one or more fields, headers, etc. added, removed, edited, changed, etc. In other words, “modify” as used herein refers to any change to the packet regardless of how that change is made.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, IAB node, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment.

In some embodiments, the non-limiting terms wireless device (WD) or UE are used interchangeably. The WD can be any type of wireless device capable of communicating with a network node or another WD over radio signals. The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipment (LEE), laptop mounted equipment (LME), USB dongles, Customer Premises Equipment (CPE), an Internet of Things (IOT) device, or a Narrowband IoT (NB-IOT) device, etc.

Herein, if IPsec tunnel mode is used to protect the traffic, the IP address refers to the outer IP address. In other cases (IPsec transport mode or no IPsec is used), there is only one IP header in the packet and hence one destination IP address in the header.

The term “descendant IAB node” may refer to both the child IAB node and the child IAB node of the child IAB node and so on.

The terms “CU_1”, “source donor” and “old donor” are used interchangeably.

The terms “CU_2”, “target donor” and “new donor” are used interchangeably.

The terms “Donor DU_1”, “source donor DU” and “old donor DU” are used interchangeably.

The terms “Donor DU_2”, “target donor DU” and “new donor DU” are used interchangeably.

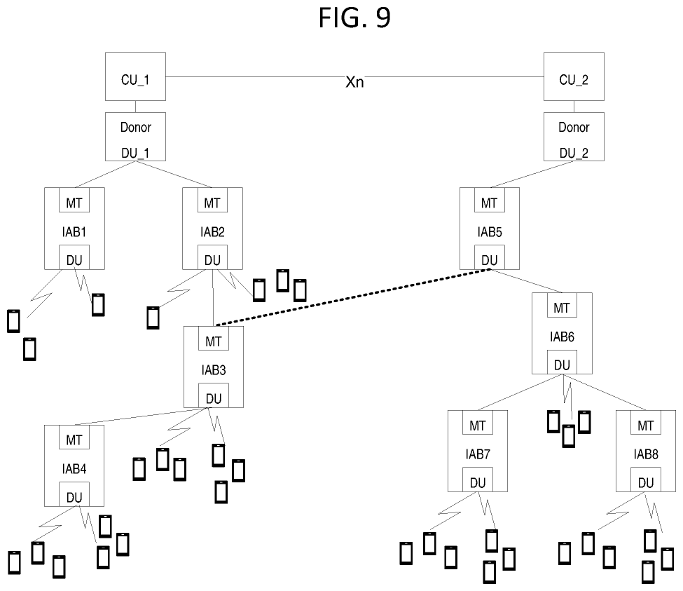

The terms “migrating IAB node” and “top-level IAB node” are used interchangeably, and they refer to the IAB-MT of this node (e.g., IAB3-MT in FIG. 9), because the collocated IAB-DU of the top-level node does not migrate (it maintains the F1 connection to the source donor).
In one example, such top-level IAB node may be an IAB, where the traffic carried to/from/via this IAB node (or part of this traffic) is taken over by (i.e., proxied) a target donor (load balancing), i.e., the source donor off-loads the traffic pertaining to certain ingress/egress BH RLC channels between the IAB node and its parent IAB node to the target donor.
In another example, the top-level IAB node may be an IAB node which is subject to a migration to the target donor, where, in one example, the migration can be executed as a consequence of a handover to the target donor, or of UL or DL local rerouting, or of an RLF experienced in the link towards the IAB node's parent, or of an RLF experienced by the IAB node's parent in the link towards its parent IAB node.
In other words, even though one or more embodiments described herein may relate to an example of inter-donor load balancing scenario, the one or more embodiments are equally applicable to any other scenario where traffic proxying over another donor is needed, where some of the non-limiting examples, in addition to inter-donor load balancing, are:
   RLF recovery caused by RLF on a link to the IAB node's parent, where the IAB node (i.e., top-level node) performs reestablishment at a parent IAB node under another donor.
   RLF recovery caused by RLF on a link between the IAB node's parent and parent's parent IAB node, where the node (i.e., top-level node) performs reestablishment at a parent IAB node under another donor.
   IAB node handover to another donor.
   Local inter-donor rerouting, where the newly selected path towards the donor or the destination IAB node leads via another donor.

The term “migration” is unambiguously used to represent the scenario in which a top-level/migrating IAB-MT is subject to a migration to the target donor, or the scenario in which the ingress/egress traffic (or a portion of it) of the top-level/migrating IAB node is off-loaded by the source donor to the target donor (load balancing). In one example, the migration can be executed as a consequence of a handover to the target donor, or of an RLF experienced in the link towards the IAB node's parent, or of an RLF experienced by the IAB node's parent in the link towards its parent.
For the load balancing scenario, if only a portion of the ingress/egress traffic is off-loaded to the target donor, the top-level IAB-MT may maintain connectivity with both source and target donor, i.e., a dual active protocol stack (DAPS) or dual connectivity (DC) is configured at the top-level IAB-MT to maintain both connections.

Top-level IAB node includes a top-level IAB-MT and its collocated IAB-DU (sometimes referred to as the “collocated DU” or the “top-level DU”). In some scenarios, the top-level IAB-MT may migrate to a target donor or establish dual connectivity to both source and target donor, while its collocated IAB-DU always maintains its F1 connection with the source donor.

The terms “RRC/F1 connections of descendant devices” refers to the RRC connections of descendant IAB-MTs and UEs (i.e., wireless devices) with the donor (source donor in this case), and the F1 connections of the top-level IAB-DU and IAB-DUs of descendant IAB nodes of the top-level IAB node.

Whenever top-level node is mentioned, it refers to the IAB node in its entirety, unless specifically stated to which of its parts it is referred to (top-level IAB-DU or top-level IAB-MT).

Traffic between the CU_1 and the top-level IAB node and/or its descendant IAB nodes (also referred to as the proxied traffic) refers to the traffic between the CU_1 and:
1. the collocated IAB-DU part of the top-level IAB node (since the IAB-MT part of the top-level IAB node has migrated its RRC connection to the new donor),
2. the descendant IAB nodes of the top-level IAB node, and
3. the wireless devices served by the top-level node and its descendant IAB nodes.

One or more embodiments described herein are applicable regardless of whether the CU has an integrated security gateway, or these are two different entities and/or regardless of whether IPsec tunnel mode or transport mode is used, or no IPsec is used at all.

In one or more embodiments, the assumption is that direct routing between CU_1 and Donor DU_2 is applied (i.e., CU_1-Donor DU_1-and so on . . . ), rather than the indirect routing case, where the traffic goes first to CU_2, i.e., CU_1-CU_2-Donor DU_1-and so on . . . . The direct routing can, e.g., be supported via IP routing between (source donor) CU_1 and donor DU2 (target donor DU) or via an Xn connection between the two. In indirect routing, data can be sent between CU_1 and CU_2 via Xn interface, and between CU_2 and Donor DU_2 via F1 or via IP routing. Both direct and indirect routing are applicable to one or more embodiments described herein. The advantage of direct routing is that the latency is likely smaller.

In one or more embodiments described herein it is assumed that, both user plane and control plane traffic are sent by means of direct and indirect routing.

According to the 3GPP Rel-16 IAB specifications, it is the IAB-MT of an IAB node that requests from the network and is assigned a number of IP addresses to be used for different types of traffic (user-plane, control-plane, non-F1, all traffic types). However, effectively, these addresses are used by the IAB-DU of the IAB node, for example for:
i. User plane traffic destined to the wireless devices or IAB-MTs served by this IAB-DU.
ii. Control plane traffic, destined to the IAB-DU itself or destined to the wireless devices or IAB-MTs served by the IAB-DU.
iii. Non-F1 traffic, e.g., OAM traffic pertaining to the IAB node.

If the text used herein refers to “IP address of the top-level IAB-MT”, it should be understood in the context of i-iii above.

The term “destination is IAB-DU”, may include both the traffic whose final destination is either the IAB-DU or a wireless device or IAB-MT served by the IAB-DU, and that includes top-level IAB-DU as well.

The term “data” refers to both user plane, control plane traffic and non-F1 traffic.

Note that although terminology from 3GPP LTE and/or NR may be used in this disclosure, this should not be seen as limiting the scope of the disclosure to only this system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs.

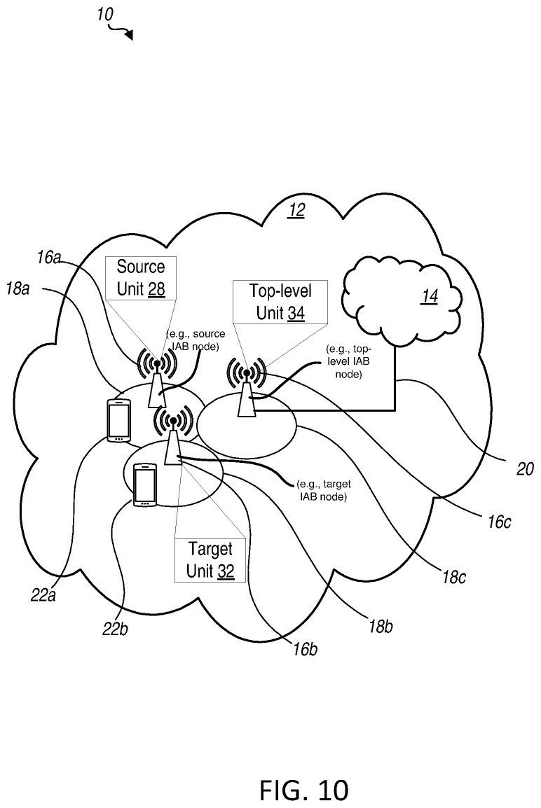

Referring again to the figures, in which like elements are referred to by like reference numerals, there is shown in FIG. 10 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of IAB nodes 16a, 16b, 16c (referred to collectively as IAB nodes 16), such as NBs, eNBs, gNBs or other types of wireless access points, each defining a corresponding coverage area 18a, 18b, 18c (referred to collectively as coverage areas 18). For example, IAB node 16a may be a source IAB node 16a (also referred to as source IAB node 16), IAB node 16b may be a target IAB node 16b (also referred to as target IAB node 16), and IAB node 16c may be a top-level IAB node 16c (also referred to as top-level IAB node 16). Each IAB node 16a, 16b, 16c is connectable to the core network 14 over a wired or wireless connection 20. A first WD 22a located in coverage area 18a is configured to wirelessly connect to, or be paged by, the corresponding IAB node 16a. A second WD 22b in coverage area 18b is wirelessly connectable to the corresponding IAB node 16b. While a plurality of WDs 22a, 22b (collectively referred to as WDs 22) are illustrated in this example, the disclosed embodiments are equally applicable to a situation where a sole WD is in the coverage area or where a sole WD is connecting to the corresponding IAB node 16. Note that although only two WDs 22 and three IAB nodes 16 are shown for convenience, the communication system may include many more WDs 22 and network nodes 16.

Also, it is contemplated that a WD 22 can be in simultaneous communication and/or configured to separately communicate with more than one IAB node 16 and more than one type of IAB node 16. For example, a WD 22 can have dual connectivity with a IAB node 16 that supports LTE and the same or a different IAB node 16 that supports NR. As an example, WD 22 can be in communication with an eNB for LTE/E-UTRAN and a gNB for NR/NG-RAN.

An IAB node 16 is configured to include one or more of source unit 28, target unit 32 and top-level unit 34. For example, source IAB node 16a may include source unit 28, target IAB node 16b may include target unit 32 and top-level IAB node 16c may include top-level unit 34.

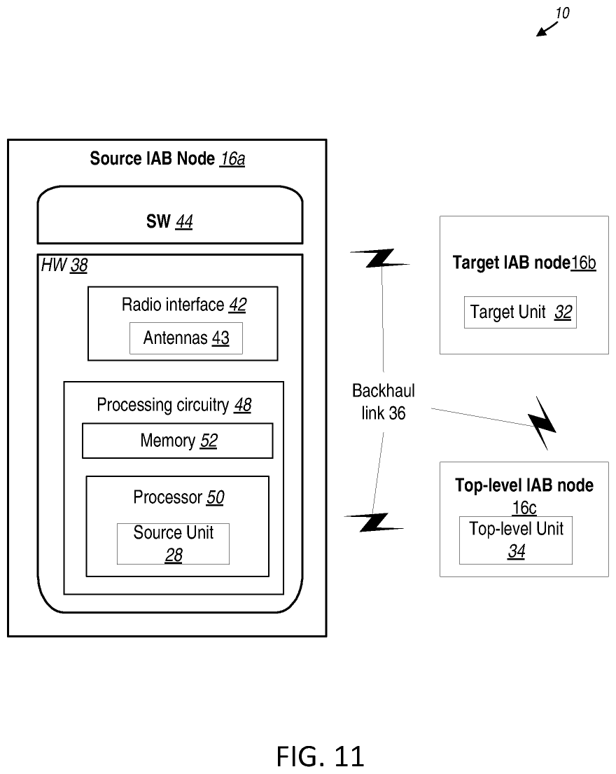

Example implementations, in accordance with an embodiment of the WD 22 and network node 16 will now be described with reference to FIG. 11.

The source IAB node 16a includes hardware 38 enabling it to communicate with the WD 22 and other IAB nodes 16. The hardware 38 may include a radio interface 42 for setting up and maintaining at least a wireless connection 46 with a WD 22 located in a coverage area 18 served by the IAB node 16a, and for performing wireless backhaul communication with one or more IAB nodes 16. The radio interface 42 may be formed as or may include, for example, one or more RF transmitters, one or more RF receivers, and/or one or more RF transceivers. The radio interface 42 includes an array of antennas 43 to radiate and receive signal carrying electromagnetic waves.

In the embodiment shown, the hardware 38 of the IAB node 16a further includes processing circuitry 48. The processing circuitry 48 may include a processor 50 and a memory 52. In addition to or instead of a processor, such as a central processing unit, and memory, the processing circuitry 48 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 50 may be configured to access (e.g., write to and/or read from) the memory 52, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the IAB node 16a further has software 44 stored internally in, for example, memory 52, or stored in external memory (e.g., database, storage array, network storage device, etc.) accessible by the IAB node 16a via an external connection. The software 44 may be executable by the processing circuitry 48. The processing circuitry 48 may be configured to control any of the methods and/or processes described herein and/or to cause such methods, and/or processes to be performed, e.g., by IAB node 16a. Processor 50 corresponds to one or more processors 50 for performing IAB node 16 functions described herein. The memory 52 is configured to store data, programmatic software code and/or other information described herein. In some embodiments, the software 44 may include instructions that, when executed by the processor 50 and/or processing circuitry 48, causes the processor 50 and/or processing circuitry 48 to perform the processes described with respect to IAB node 16a. For example, processing circuitry 48 of the IAB node 16 may include source unit 28, target unit 32 and/or top-level unit 34 depending on the configuration of the respective IAB node 16, where these units 28, 32, and 34 are each configured to perform one or more IAB node 16 functions as described, such as with respect to inter-donor routing in IAB networks. Further, source IAB node 16a and target IAB node 16b, which respectively act as a donor IAB node may be configured with a DU and CU, whereas the top-level IAB node 16c may be configured with a DU and MT, as described herein.

Target IAB node 16b include corresponding hardware and software as described with respect to source IAB node 16a except that target IAB node 16b is configured with target unit 32. Further, top-level IAB node 16c includes corresponding hardware and software as described with respect to source IAB node 16a except that top-level IAB node 16c is configured with top-level unit 34.

In some embodiments, the inner workings of the IAB nodes 16 may be as shown in FIG. 11 and independently, the surrounding network topology may be that of FIG. 10.

Although FIGS. 10 and 11 show various “units” such as source unit 28, target unit 32 and top-level unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

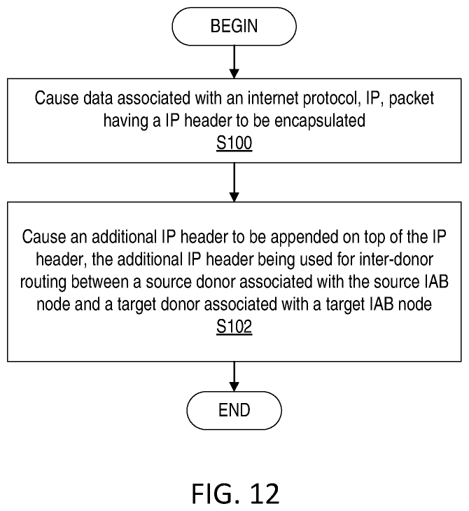

FIG. 12 is a flowchart of an example process in a source IAB node 16a for inter-donor routing in IAB networks. One or more blocks described herein may be performed by one or more elements of source IAB node 16a such as by one or more of processing circuitry 48 (including the source unit 28), processor 50, and/or radio interface 42. Source IAB node 16a is configured to cause (Block S100) data associated with an IP packet having a IP header to be encapsulated, as described herein. Source IAB node 16a is configured to cause (Block S102) an additional IP header to be appended on top of the IP header where the additional IP header is used for inter-donor routing between a source donor associated with the source IAB node 16a and a target donor associated with a target IAB node 16b.

According to one or more embodiments, the additional IP header includes an IP destination address of a IAB-mobile termination of top-level IAB node 16c, as described herein. According to one or more embodiments, causing the encapsulation and causing the additional IP header to be appended corresponds to one of: for downlink data, the source IAB node 16a performs the encapsulating and appending; and for uplink data, the source IAB node 16a instructs a top-level IAB node 16c to perform the encapsulating and appending.

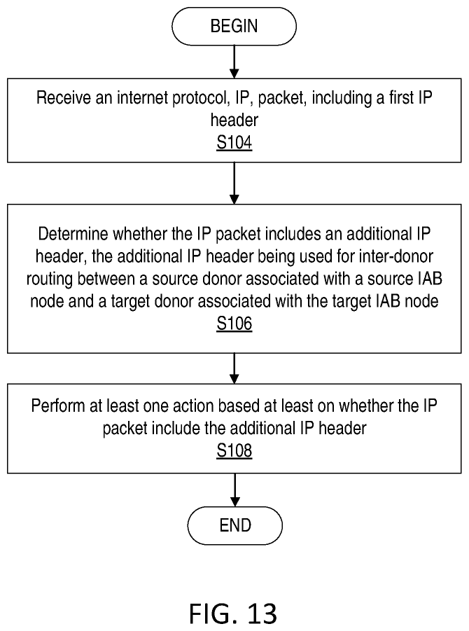

FIG. 13 is a flowchart of an example process in a target IAB node 16b for inter-donor routing in IAB networks. One or more blocks may be performed by one or more elements of target IAB node 16b (e.g. one or more of processing circuitry 48 (including the source unit 28), processor 50, and/or radio interface 42). Target IAB node 16b is configured to receive (Block S104) an IP packet, including a first IP header. Target IAB node 16b is configured to determine (Block S106) whether the IP packet includes an additional IP header where the additional IP header is used for inter-donor routing between a source donor associated with a source IAB node 16 and a target donor associated with the target IAB node 16b. Target IAB node 16b is configured to perform (Block S108) at least one action based at least on whether the IP packet include the additional IP header, as described herein.

According to one or more embodiments, the IP packet is a downlink IP packet, and the at least one action includes: constructing a BAP header for the downlink IP packet where the BAP header includes a BAP routing identifier, ID, associated with one of: a IP destination address indicated in the additional IP header, and an IP destination address indicated in the first IP header. The at least one action includes transmitting a BAP PDU, associated with the BAP header and downlink IP packet over a backhaul air interface (such as via a backhaul link/network). According to one or more embodiments, the IP packet is an uplink IP packet, and the at least one action includes transmitting the uplink IP packet to the source donor associated with a source IAB node 16a where an IP destination address includes in the additional IP header being associated with the source donor.

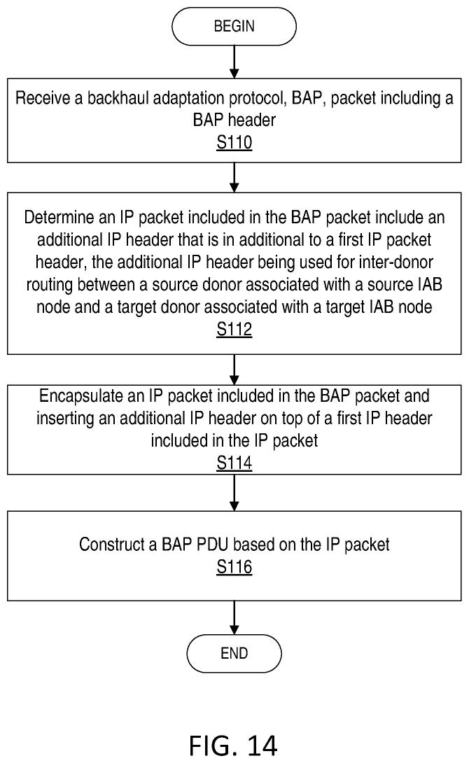

FIG. 14 is a flowchart of an example process in a top-level IAB node 16 for inter-donor routing in IAB networks. One or more blocks described herein may be performed by one or more elements of top-level IAB node 16 (e.g. one or more of processing circuitry 48 (including the top-level unit 34), processor 50, and/or radio interface 42). Top-level IAB node 16 is configured to receive (Block S110) a BAP packet including a BAP header, as described herein. The top-level IAB node 16 is configured to one of: determine an IP packet included in the BAP packet include an additional IP header that is in addition to a first IP packet header where the additional IP header is used for inter-donor routing between a source donor associated with a source IAB node 16a and a target donor associated with a target IAB node 16b; and encapsulate an IP packet included in the BAP packet and insert the additional IP header on top of a first IP header included in the IP packet. The top-level IAB node 16 is configured to construct a BAP PDU based on the IP packet.

According to one or more embodiments, the BAP packet is a downlink BAP packet. According to one or more embodiments, the BAP packet is an uplink BAP packet from a descendant IAB node 16.

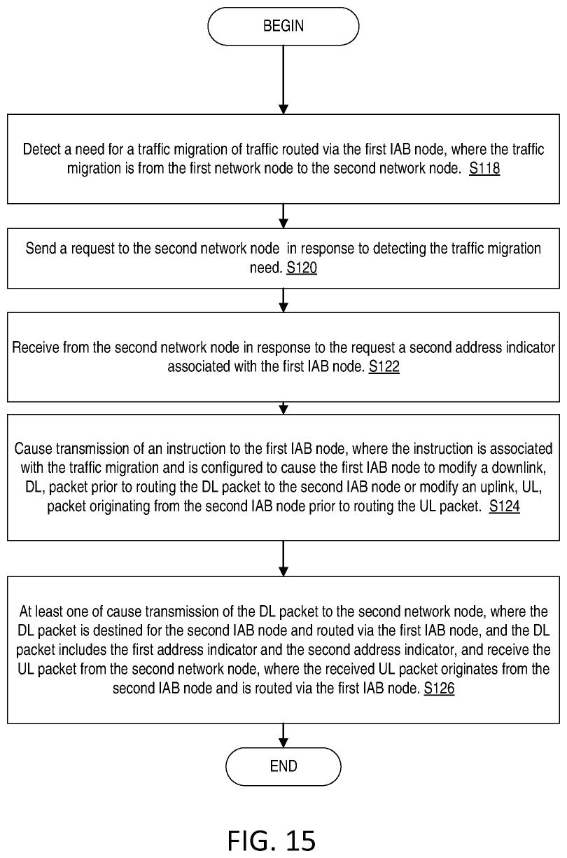

FIG. 15 is a flowchart of an example process in a first network node 16a according to some embodiments of the present disclosure. One or more blocks described herein may be performed by one or more elements of first network node 16a such as by one or more of processing circuitry 48 (including the source unit 28), processor 50, and/or radio interface 42. In one or more embodiments, first network node 16a is configured to detect (Block S118) a need for a traffic migration of traffic routed via the first IAB node 16c, where the traffic migration is from the first network node 16a to the second network node 16b. The first network node 16a is further configured to send (Block S120) a request to the second network node 16b in response to detecting the traffic migration need. The first network node 16a is configured to receive (Block S122), from the second network node 16b in response to the request, a second address indicator associated with the first IAB node 16c. The first network node 16a is configured to cause transmission (Bock S124) of an instruction to the first IAB node 16c, where the instruction is associated with the traffic migration and is configured to cause the first IAB node 16c to modify a downlink, DL, packet prior to routing the DL packet to the second IAB node 16c or modify an uplink, UL, packet originating from the second IAB node 16c prior to routing the UL packet. The first network node 16a is configured to cause transmission (Block S126) of the DL packet to the second network node 16b, where the DL packet is destined for the second IAB node 16c and routed via the first IAB node 16c, and the DL packet includes the first address indicator and the second address indicator, or is configured to receive the UL packet from the second network node 16b, where the received UL packet originates from the second IAB node 16c and is routed via the first IAB node 16c.

According to one or more embodiments, the first address indicator is at least one of an internet protocol, IP, address associated with the first network node 16a, and an IP address associated with the second IAB node 16c, and the second address indicator is at least one of an IP address associated with the second network node 16b, and an IP address associated with the first IAB node 16c.

According to one or more embodiments, the instruction is configured to cause the first IAB node 16c to modify the DL packet by removing the second address indicator from the DL packet.

According to one or more embodiments, causing transmission of the DL packet includes generating a first internet protocol, IP, header, in the DL packet, where the first IP header is based on the first address indicator, and generating a second IP header, where the second IP header is based on the second address indicator. In some embodiments, causing transmission further includes appending the second IP header to the first IP header in the DL packet.

According to one or more embodiments, the instruction is configured to cause the first IAB node 16c to modify the DL packet by removing the second IP header from the DL packet.

According to one or more embodiments, the UL packet includes a first internet protocol, IP, header based on the first address indicator, and the instruction is configured to cause the first IAB node to modify the UL packet by generating a second IP header based on at least one of the instruction and the second address indicator and appending the second IP header to the first IP header in the UL packet.

According to one or more embodiments, the first network node 16c is further configured to, subsequent to receiving the UL packet, cause the second IP header to be removed from the received UL packet.

According to one or more embodiments, the instruction includes a mapping of internet protocol, IP, addresses to corresponding Backhaul Adaptation Protocol, BAP, routing identifiers. The instruction is configured to cause the first IAB node either modify the UL packet by removing a first BAP header from the UL packet based on a BAP routing identifier of the first BAP header being associated with the first network node 16a, generating a second BAP header based on the mapping, and appending the second BAP header to the UL packet, or configured to modify the DL packet by generating a BAP header based on the mapping, and appending the BAP header to the DL packet.

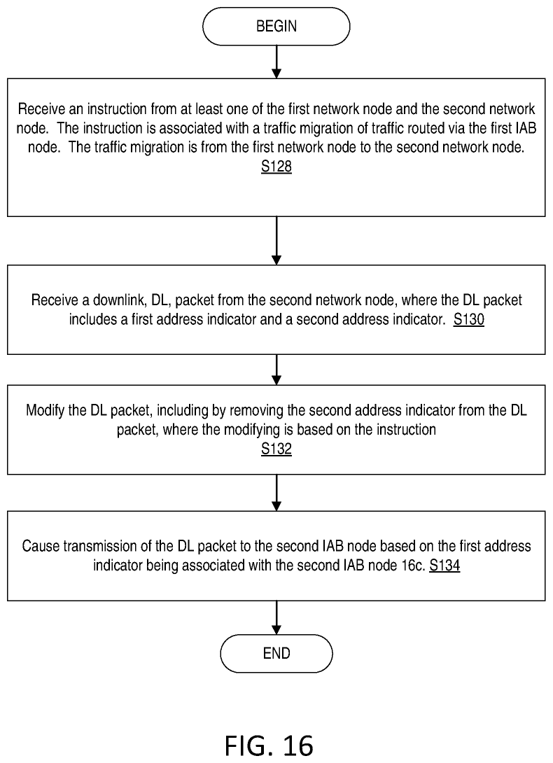

FIG. 16 is a flowchart of an example process in a first IAB node 16c for inter-donor routing in integrated access and backhaul (IAB) networks. One or more blocks described herein may be performed by one or more elements of first IAB node 16c such as by one or more of processing circuitry 48 (including the top-level unit 34), processor 50, and/or radio interface 42. First IAB node 16c is configured to receive (Block S128) an instruction from at least one of the first network node 16a and the second network node 16b. The instruction is associated with a traffic migration of traffic routed via the first IAB node 16c. The traffic migration is from the first network node 16a to the second network node 16b. The first IAB node is configured to receive (Block S130) a downlink, DL, packet from the second network node 16b, where the DL packet includes a first address indicator and a second address indicator. The first IAB node 16c is configured to modify (Block S132) the DL packet, including by removing the second address indicator from the DL packet, where the modifying is based on the instruction. The first IAB node 16c is configured to cause transmission (Block S134) of the DL packet to the second IAB node 16c based on the first address indicator being associated with the second IAB node 16c.

According to one or more embodiments, the first address indicator is at least one of an internet protocol, IP, address associated with the first network node 16a, and an IP address associated with the second IAB node 16c; and the second address indicator is at least one of an IP address associated with the second network node 16b, and an IP address associated with the first IAB node 16c.

According to one or more embodiments, the instruction includes a mapping of internet protocol, IP, addresses to corresponding Backhaul Adaptation Protocol, BAP, routing identifiers, and the modifying includes generating a BAP header based on the mapping and appending the BAP header to the DL packet.

According to one or more embodiments, the first IAB node 16c is configured to discard the DL packet based on the second address indicator not being associated with the first IAB node or the first address indicator not being associated with either of the first IAB node 16c and a destination address associated with the first IAB node 16c.

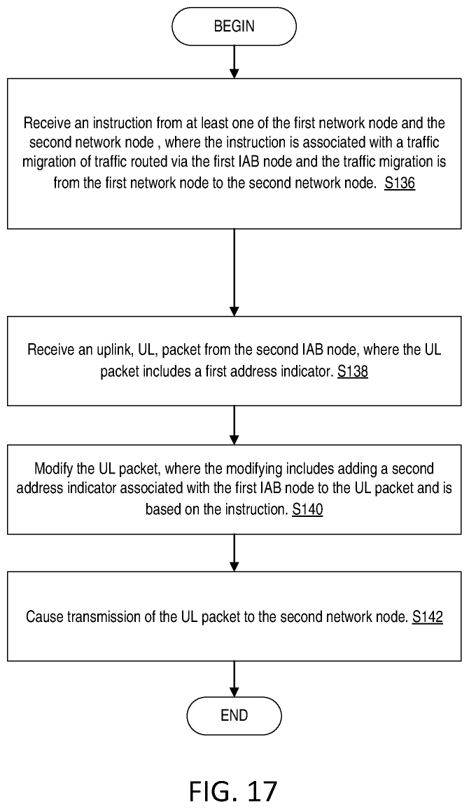

FIG. 17 is a flowchart of an example process in a first IAB node 16c for inter-donor routing in integrated access and backhaul (IAB) networks. One or more blocks described herein may be performed by one or more elements of first IAB node 16c such as by one or more of processing circuitry 48 (including the top-level unit 34), processor 50, and/or radio interface 42. First IAB node 16c is configured to receive (Block S136) an instruction from at least one of the first network node 16a and the second network node 16b, where the instruction is associated with a traffic migration of traffic routed via the first IAB node 16c and the traffic migration is from the first network node 16a to the second network node 16b. The first IAB node 16c is configured to receive (Block S138) an uplink, UL, packet from the second IAB node 16c, where the UL packet includes a first address indicator. The first IAB node 16c is configured to modify (Block S140) the UL packet, where the modifying includes adding a second address indicator associated with the first IAB node to the UL packet and is based on the instruction. The first IAB node 16c is configured to cause transmission (Block S142) of the UL packet to the second network node.

According to one or more embodiments, the first address indicator is at least one of an internet protocol, IP, address associated with the first network node 16a, and an IP address associated with the second IAB node 16c; and the second address indicator is at least one of an IP address associated with the second network node 16b, and an IP address associated with the first IAB node 16c.

According to one or more embodiments, the UL packet includes a first internet protocol, IP, header based on the first address indicator, and modifying the UL packet includes generating a second IP header based on either the instruction or the second address indicator, and appending the second IP header to the first IP header in the UL packet.

According to one or more embodiments, the instruction includes a mapping of internet protocol, IP, addresses to corresponding Backhaul Adaptation Protocol, BAP, routing identifiers, and modifying the UL packet includes removing a first BAP header included in the UL packet based on a BAP routing identifier of the first BAP header being associated with the first network node 16a, generating a second BAP header based on the mapping, and appending the second BAP header to the UL packet.

Having described the general process flow of arrangements of the disclosure and having provided examples of hardware and software arrangements for implementing the processes and functions of the disclosure, the sections below provide details and examples of arrangements for inter-donor routing in IAB networks.

One or more network node 16a (also referred to as source IAB node 16a) functions described below may be performed by one or more of processing circuitry 48, processor 50, radio interface 42, source unit 28, etc. One or more network node 16b (also referred to as target IAB node 16b) functions described below may be performed by one or more of processing circuitry 48, processor 50, radio interface 42, target unit 32, etc. One or more IAB node 16c (also referred to as top-level node, top-level node 16, or top-level IAB node 16c) functions described below may be performed by one or more of processing circuitry 48, processor 50, radio interface 42, top-level unit 34, etc.

### Method for Packet Handling at the Source Donor (i.e., Source IAB Node 16a)

To address one or more problems with existing systems (i.e., avoid the conflicting requirements described above), the method for the source donor CU includes the following steps, presented with respect to the example scenario of FIG. 9:

For downstream (i.e. downlink) traffic:

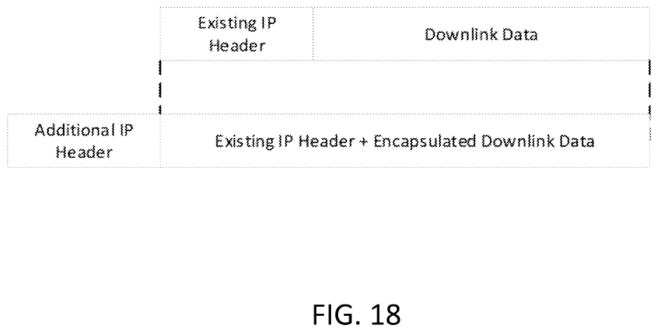

Prior to sending a DL packet to IAB4 (via Donor DU_2), the CU_1 or its security gateway (e.g., IPsec SecGW), encapsulates the DL packet and inserts an additional IP header, by appending this additional header on top of existing IP header as shown in FIG. 18.

The existing IP header is described in the IP and IPsec (IETF) specifications, whereas the IPsec and IP layer are a part of both the F1-U and F1-C protocol stacks. The term “existing IP header” is chosen to differentiate these legacy IP headers from the “additional IP header” described herein:

1. In cases where IPsec tunnel mode is used, the existing IP header consists of the outer and inner IP headers, bearing, among other fields, the outer IP destination address and inner IP destination address, respectively.

2. In cases where IPsec transport mode is used or no IPsec is used at all, the existing IP header consists of only one IP header, with a single destination IP address.

3. The IP destination address pertains to the destination of the downlink data encapsulated in the DL packet. This can be the IAB-DU of the top-level IAB node, or a descendant IAB-DU or IAB-MT, depending on the destination of the downlink data. This IP destination address may be assigned when the concerned IAB-DU of the top-level IAB node, or a descendant IAB-DU or IAB-MT is still attached to the source donor centralized unit 1 (CU1), e.g., as part of the bootstrapping procedure.

And the additional IP header, added to the packet, may include the following examples, among other fields:

1. The IP destination address of the top-level IAB node 16c's IAB-MT (this IP address is from the IP address domain of the target donor DU (Donor DU_2, which is under CU_2)), where the top-level IAB node 16c is the ancestor of the IAB node 16 to which the downlink data encapsulated in the DL packet are destined, and where the IP destination address is assigned by the target donor CU2 when the top level IAB-MT attaches to it. The following is noted:

a. Clarification: the IAB-MT of the top-level IAB node 16c is connected to the target donor, and the destination IP address in the additional IP header pertains to the IAB-MT of the top-level IAB node 16c, but, in the context of one or more embodiments described herein, the additional IP header in fact encapsulates the traffic destined to the IAB-DU of the top-level IAB node 16, or a descendant IAB-DU or IAB-MT, depending on the destination of the downlink data.

b. The top-level IAB-MT may be assigned one or more IP addresses to be used for the purpose described herein, i.e., to be used as the destination IP address in the additional IP header (for DL traffic) or source IP address of the additional IP header (for UL traffic).

c. The IP destination address assigned by the target CU2 to the top-level IAB 16 node may communicated to the source CU1 during the migration procedure, i.e., before the source donor starts forwarding downlink data to the target.

2. The source IP address from the IP address domain of the target donor DU, pertaining to the source of the packet (e.g., CU_1 or the CU-Control Plane (CP) or the CU_user plane (UP) in CU_1 or the Operations, Administration and Maintenance (OAM system).

3. The additional header also contains the DSCP and flow label fields, that may be used, in addition to the destination IP address in the additional IP header, to derive the BAP routing ID at the target donor DU.

CU_1 (or its security gateway) sends the resulting packet containing the additional and existing IP header to Donor DU_2, e.g., via Xn interface.

In another embodiment, the IP destination address indicated in the additional IP header may be included in a field appended to the GTP-U header and transmitted over the Xn, rather than to the IP header as disclosed previously. In another method of this embodiment, rather than the IP destination address, the source donor indicates in the field appended to the GTP-U header the BAP address of the top-level IAB node 16c, wherein the BAP address can be the BAP address of such IAB node as configured by the source donor before the migration, or the BAP address of such IAB node as configured by the target IAB node 16b upon migration. In the first case, it is assumed that the source donor indicates to the target donor, e.g., during the migration procedure (HO preparation, DAPS configuration), or SN-addition, about the configured BAP address. In the second case, it is assumed that the target donor indicates to the source IAB node the BAP address of the top-level IAB node, e.g., during the migration procedure (HO preparation, DAPS configuration), or SN-addition response.

For upstream (i.e. uplink) traffic:

To enable UL packet handling at the top-level IAB node 16c, CU_1 may instruct the top-level IAB node 16c which source and destination IP addresses to use when encapsulating UL packets into the additional IP header.
Alternatively, CU_2 (e.g., target IAB node 16b) may configure the top-level IAB node 16c how to execute the above.
Herein, the UL traffic includes the traffic originating at one or more of:
   The IAB-DU of the top-level IAB node 16c or one or more IAB-MTs or wireless devices that it serves.
   The descendant IAB-MTs or IAB-DUs or the wireless devices served therein.

Upon receiving an UL packet from top-level IAB node 16c or the descendant nodes of the top-level IAB node 16c, CU_1 (e.g., source IAB node 16a) (or its security gateway) may remove the additional IP header before processing the packet. If the CU_1 has an integrated security gateway, or if IPsec is not used, the additional IP header is added by the CU_1. If the CU_1 and its security gateway are two different entities, the additional IP header may be assembled and added to the packet by the security gateway, as instructed by the CU_1.

Method for Target Donor DU (e.g., Target IAB Node 16b) to Assemble the BAP Header for Packets Received from the Source CU

For downstream (i.e., downlink) traffic, the method of the target donor DU includes:

Determining whether the DL packet received from the source donor (e.g., source IAB node 16a), (e.g., directly via IP routing, or indirectly, target CU, as described earlier), contains or not the additional IP header.

If the packet contains the additional IP header, the target donor DU may construct a BAP header for the packet and include, in the BAP header, the BAP Routing ID (includes a BAP destination address and path ID) associated to the IP destination address indicated in the additional IP header, where the mapping between BAP Routing ID and IP destination address for the top-level IAB node 16c is determined during the migration procedure.
In one or more embodiments, the target donor (i.e., target IAB node 16b) ignores the content of the existing IP header.
In one or more embodiments, the BAP Routing ID is derived, in addition to the destination IP address in the additional IP header, also based on the DSCP/DS and/or flow label fields in the additional IP header.

Otherwise, if the packet does not contain the additional IP header, e.g., it is a packet not coming via the Xn, inspect the existing IP header and construct a BAP header for the packet by including in the BAP header, the BAP Routing ID (including BAP destination address and path ID) associated to the IP destination address indicated in the existing IP header.

In cases where the IP destination address, or BAP address is included in the GTP-U packet, as described above, the target donor node (i.e., target IAB node 16b) performs the above step by inspecting the GTP-U header, i.e., the target donor node constructs a BAP header for the packet by including in the BAP header the BAP Routing ID (including BAP destination address and path ID) associated to the IP destination address indicated in the GTP-U header. If the GTP-U header contains the BAP address of the top-level IAB node 16c, the BAP routing ID selected includes the same BAP address and a path ID associated to it.

Transmit the resulting BAP PDU with the built BAP header over the backhaul air interface.

For upstream (i.e., uplink) traffic:

Determining whether the UL packet received from the backhaul air interface contains the additional IP header.

If the UL packet contains the additional IP header, transmits the packet to the source donor node whose IP destination corresponds to the IP destination included in the additional IP header in the received packet.

### Method at the Top-Level IAB Node

As described above, it may be useful to avoid IP address reconfiguration of the descendant IAB nodes 16 of the top-level IAB node 16c. This means that the top-level IAB node 16c needs to appropriately handle the traffic to/from CU_1. The mechanisms for doing so are as follows:

For downstream (i.e., DL) traffic, the methods for the top-level IAB node 16c (e.g., IAB3 in FIG. 9 according to the new functionality described herein) may include the following:

1. Receiving a DL BAP packet from its parent IAB node under CU_2, inspecting the BAP header and determining if the BAP address included in the received BAP packet corresponds to its BAP address.

2. If the BAP address included in the received BAP packet corresponds to top-level IAB node 16c's BAP address, passing the BAP packet to higher layers in the protocol stack, e.g., the BAP layer in the top-level IAB-MT passes the packet to the IP layer, where the higher layers may perform the following methods:
Inspecting the IP header, and determining if the IP packet contains downlink data which are destined to the concerned top-level IAB node 16 (e.g., the top-level IAB-DU) or to a descendant IAB node 16. Such action may imply determining whether the IP packet has an additional IP header containing an IP destination address corresponding to the IP address of the said top-level IAB node 16c, and determining whether:
   1) The destination IP addresses in the “existing” IP header pertains the collocated IAB-DU (i.e., the IAB-DU of the top-level IAB node 16c), or 2) a descendant node. In the former case 1), the concerned top level IAB-DU node is the destination of the DL data contained in the IP packet. In the latter case 2), a descendant IAB node 16 of the concerned top-level IAB node 16c is the destination of the DL data contained in the IP packet.

Removing the additional IP header and determining, based on the destination address in the existing IP header, whether the DL packet is destined to the concerned top-level IAB node's collocated IAB-DU or to a descendant IAB node 16.

If the destination of the packet is the collocated IAB-DU of the top-level IAB-MT (i.e., the top-level IAB-DU) (case 1 above), passing the packet to the higher layers or the collocated IAB-DU for further processing, whereas the final destination of the packet may be either the collocated IAB-DU of the top-level IAB-MT or one or more WDs 22 or IAB-MTs served by this top-level IAB-DU.

If the destination of the packet is a descendant IAB node (case 2) above), passing to lower layers the resulting IP packet, and performing step 3 described below.

If, from the above actions, it is determined that: 1: the IP packet contains an IP destination address in the existing IP header that does not match any IP address in the routing table of the top-level IAB node 16c, and it does not match the IP address of the concerned top level node either 2: the IP packet contains an IP destination address in the additional IP header that does not match the IP address of the present top-level IAB node 16c, then the top-level IAB node 16c discards the IP packet.
This may be considered as an error case, i.e., the top-level IAB-MT has received a packet with an IP destination address in the existing IP header which does not match any of the destination IP addresses in the existing IP header that the node is configured to handle. Or the top-level IAB-MT has received a packet which has a BAP address matching the BAP destination of the top-level IAB node 16c, but the IP address in the IP additional header does not match the IP address of the concerned top-level IAB node 16c.

In one example, the step 2 is always performed for any BAP packet received in the downstream direction if the top-level IAB node 16c has performed a migration and still has F1 connectivity to the source donor. In another example instead, such method is only performed for the BAP packet of the ingress BH RLC channels which are associated to a parent node controlled by the target donor (e.g., IAB5 in FIG. 9). The latter example applies in case load balancing is performed for certain traffics, and the top-level IAB-MT is dual-connected with the source donor and target donor (e.g., via DC or DAPS).

3. Receiving from higher layers the resulting IP packet and determining the BAP routing ID (which in turn includes a BAP destination address, and path ID) associated to the IP destination address indicated in the existing IP header, i.e., the IP address of the descendant node to which the downlink data are intended. The mapping between BAP routing ID and IP address may be provided by the source CU prior or after the migration.
In one method, the above step is performed by the IAB-DU collocated in the top-level IAB node, in another method the above step is performed by the top-level IAB-MT.

4. Constructing a BAP PDU with a BAP header including the BAP Routing ID selected at the previous step.

5. Transmitting the resulting BAP PDU in the downstream according to the selected BAP routing ID.

For upstream (i.e., UL) traffic, the methods for the top-level IAB node 16c (e.g., IAB3 in FIG. 9 as modified to include the functionality described herein) includes the following:

1. Receiving an UL BAP packet from a descendant node including in the BAP header a BAP routing ID associated the CU_1 network (i.e., BAP destination is the BAP address of the source donor). This is because the BAP header is assembled by a descendant IAB node 16 which may be unaware that the traffic that it is the origin of is proxied via a target donor by a top-level IAB node 16c. In one example, such method is always performed for any BAP packet received in the upstream direction if the top-level IAB-MT has performed a migration and its collocated top-level IAB-DU has F1 connectivity to the source donor (i.e., source IAB node 16a). In another example, instead, such method is only performed for the BAP packet associated to certain ingress BH RLC channels or certain path IDs. The latter example applies in case load balancing is performed for certain traffics, and the top-level IAB-MT is dual-connected with the source donor and target donor (e.g. via DC or DAPS)

2. Removing the BAP header, if the included BAP routing ID is associated to the source donor, and passing the resulting BAP packet to higher layers, e.g. the top-level IAB-MT passes the BAP packet to the IP layer.

3. Encapsulating the UL packet and inserting an additional IP header, by appending this additional header on top of existing IP header, as instructed by CU_1. In other words, CU_1 configures the top-level IAB node 16c with how to assemble the additional IP header based on the content of the existing IP header.
Herein, the existing IP header is assembled by the IAB node 16 from which the packet originates, the following holds:
   In case IPsec tunnel mode is used, the existing IP header consists of the outer and inner IP headers, bearing, among other fields, the outer IP destination address and inner IP destination address, respectively:
      The IP destination address in the existing header pertains to the source donor to which the uplink data are destined.
   In case IPsec transport mode is used or no IPsec is used at all, the existing IP header contains only one IP header with a single destination IP address.
And wherein the additional IP header includes the destination IP address of the source donor (or an entity therein, such as donor CU-CP, or donor CU-CP) or the OAM system. For example, the target donor at migration may indicate the IP destination of the target donor which should be appended to the IP header.
NOTE: “As instructed by CU_1” above implies that the processing is performed in the IAB-DU of the top-level IAB node 16c because the said IAB-DU is managed by CU_1. In addition, in one variant, the CU_2 may configure the top-level IAB-MT to perform the processing described.

4. Receiving from higher layers the resulting IP packet and determining the BAP routing ID (which in turn includes a BAP destination address, and path ID) associated to the destination IP address included by higher layers in the additional IP header, i.e., the IP address of the source donor. The mapping between BAP routing ID and source donor IP address may be provided by the target donor CU to source CU during the migration.
In one method, the above step is performed by the IAB-MT of the top-level IAB node 16, in another method the above step is performed by the collocated top-level IAB-DU.

5. Constructing a BAP PDU with a BAP header including the BAP Routing ID selected at the previous step.

6. Transmitting the resulting BAP PDU in the upstream according to the selected BAP routing ID.

Therefore, in one or more embodiments, a solution is provided for enabling inter-donor traffic load balancing in IAB networks (where the traffic between a donor and an IAB node traverses the network under another donor), without affecting or reconfiguring the IP addresses of the descendants of the top-level IAB node, which, in turn, simplifies and accelerates the load balancing procedure as compared with known solutions and arrangements.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. All embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. A variety of modifications and variations are possible in light of the above teachings without departing from the scope of the following claims.

1. A first network node in communication with a second network node and a first integrated access and backhaul, IAB, node which is in communication with a second IAB node, the first network node being associated with a first address indicator and comprising processing circuitry configured to:
detect a need for a traffic migration of traffic routed via the first IAB node, the traffic migration being from the first network node to the second network node;
in response to the detecting, send a request to the second network node;
receive, from the second network node in response to the request, a second address indicator associated with the first IAB node;
cause transmission of an instruction to the first IAB node, the instruction being associated with the traffic migration and configured to cause the first IAB node modify a downlink, DL, packet prior to routing the DL packet to the second IAB node or modify an uplink, UL, packet originating from the second IAB node prior to routing the UL packet; and
at least one of:
cause transmission of the DL packet to the second network node, the DL packet being destined for the second IAB node and being routed via the first IAB node, the DL packet including the first address indicator and the second address indicator; and
receive the UL packet from the second network node, the received UL packet originating from the second IAB node and being routed via the first IAB node.

2. The first network node of claim 1, wherein:
the first address indicator is at least one of:
an internet protocol, IP, address associated with the first network node, and
an IP address associated with the second IAB node; and
the second address indicator is at least one of:
an IP address associated with the second network node, and
an IP address associated with the first IAB node.

3. The first network node of claim 1, wherein the instruction is configured to cause the first IAB node to modify the DL packet by removing the second address indicator from the DL packet.

4. The first network node of claim 1, wherein the causing transmission of the DL packet includes:
generating a first internet protocol, IP, header, in the DL packet, the first IP header being based on the first address indicator;
generating a second IP header, the second IP header being based on the second address indicator; and
appending the second IP header to the first IP header in the DL packet.

5. The first network node of claim 4, wherein the instruction is configured to cause the first IAB node to modify the DL packet by removing the second IP header from the DL packet.

6. The first network node of claim 1, wherein the UL packet includes a first internet protocol, IP, header based on the first address indicator, the instruction being configured to cause the first IAB node to modify the UL packet by:
generating a second IP header based on at least one of the instruction and the second address indicator; and
appending the second IP header to the first IP header in the UL packet.

7. The first network node of claim 6, wherein the processing circuitry of the first network node is further configured to:
subsequent to receiving the UL packet, cause the second IP header to be removed from the received UL packet.

8. The first network node of claim 1, wherein the instruction includes a mapping of internet protocol, IP, addresses to corresponding Backhaul Adaptation Protocol, BAP, routing identifiers, the instruction being configured to cause the first IAB node to at least one of:
modify the UL packet by:
removing a first BAP header from the UL packet based on a BAP routing identifier of the first BAP header being associated with the first network node;
generating a second BAP header based on the mapping; and
appending the second BAP header to the UL packet; and
modify the DL packet by:
generating a BAP header based on the mapping; and
appending the BAP header to the DL packet.

9. A method implemented in a first network node in communication with a second network node and a first integrated access and backhaul, IAB, node which is in communication with a second IAB node, the first network node being associated with a first address indicator, the method comprising:
detecting a need for a traffic migration of traffic routed via the first IAB node, the traffic migration being from the first network node to the second network node;
in response to the detecting, sending a request to the second network node;
receiving, from the second network node in response to the request, a second address indicator associated with the first IAB node;
causing transmission of an instruction to the first IAB node, the instruction being associated with the traffic migration and configured to cause the first IAB node modify a downlink, DL, packet prior to routing the DL packet to the second IAB node or modify an uplink, UL, packet originating from the second IAB node prior to routing the UL packet; and
at least one of:
causing transmission of the DL packet to the second network node, the DL packet being destined for the second IAB node and being routed via the first IAB node, the DL packet including the first address indicator and the second address indicator; and
receiving the UL packet from the second network node, the received UL packet originating from the second IAB node and being routed via the first IAB node.

10. The method of claim 9, wherein:
the first address indicator is at least one of:
an internet protocol, IP, address associated with the first network node, and
an IP address associated with the second IAB node; and
the second address indicator is at least one of:
an IP address associated with the second network node, and
an IP address associated with the first IAB node.

11. The method of claim 9, wherein the instruction is configured to cause the first IAB node to modify the DL packet by removing the second address indicator from the DL packet.

12. The method of claim 9, wherein the causing transmission of the DL packet includes:
generating a first internet protocol, IP, header, in the DL packet, the first IP header being based on the first address indicator;
generating a second IP header, the second IP header being based on the second address indicator; and
appending the second IP header to the first IP header in the DL packet.

13. The method of claim 12, wherein the instruction is configured to cause the first IAB node to modify the DL packet by removing the second IP header from the DL packet.

14. The method of claim 9, wherein the UL packet includes a first internet protocol, IP, header based on the first address indicator, the instruction being configured to cause the first IAB node to modify the UL packet by:
generating a second IP header based on at least one of the instruction and the second address indicator; and
appending the second IP header to the first IP header in the UL packet.

15. The method of claim 14, wherein the processing circuitry of the first network node is further configured to:
subsequent to receiving the UL packet, cause the second IP header to be removed from the received UL packet.

16. The method of claim 9, wherein the instruction includes a mapping of internet protocol, IP, addresses to corresponding Backhaul Adaptation Protocol, BAP, routing identifiers, the instruction being configured to cause the first IAB node to at least one of:
modify the UL packet by:
removing a first BAP header from the UL packet based on a BAP routing identifier of the first BAP header being associated with the first network node;
generating a second BAP header based on the mapping; and
appending the second BAP header to the UL packet; and
modify the DL packet by:
generating a BAP header based on the mapping; and
appending the BAP header to the DL packet.

17. A first integrated access and backhaul, IAB, node, in communication with a second IAB node, a first network node, and a second network node, the first IAB node comprising processing circuitry configured to:
receive an instruction from at least one of the first network node and the second network node, the instruction being associated with a traffic migration of traffic routed via the first IAB node, the traffic migration being from the first network node to the second network node;
receive a downlink, DL, packet from the second network node, the DL packet including a first address indicator and a second address indicator;
modify the DL packet, the modifying including removing the second address indicator from the DL packet, the modifying being based on the instruction; and
cause transmission of the DL packet to the second IAB node based on the first address indicator being associated with the second IAB node.

18. The first IAB node of claim 17, wherein:
the first address indicator is at least one of:
an internet protocol, IP, address associated with the first network node, and
an IP address associated with the second IAB node; and
the second address indicator is at least one of:
an IP address associated with the second network node, and
an IP address associated with the first IAB node.

19. The first IAB node of claim 17, wherein the instruction includes a mapping of internet protocol, IP, addresses to corresponding Backhaul Adaptation Protocol, BAP, routing identifiers, the modifying further including:
generating a BAP header based on the mapping; and
appending the BAP header to the DL packet.

20. The first IAB node of claim 18, wherein the processing circuitry is further configured to:
discard the DL packet based on at least one of:
the second address indicator not being associated with the first IAB node, and
the first address indicator not being associated with at least one of:
the first IAB node, and
a destination address associated with the first IAB node.

21.-32. (canceled)
